(19) United States
(12) Patent Application Publication
(10) Pub. No.: US 2006/0096717 A1
(43) Pub. Date: May 11, 2006

(54) Indoor crime preventer

(76) Inventor: Junko Suginaka, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/515,183

(22) PCT Filed: May 30, 2002
(86) PCT No.: PCT/JP02/05268

§ 371 Date: Sep. 6, 2005

(51) Int. Cl. E06B 9/30

(52) U.S. Cl. 160/168.1 R

(57) ABSTRACT

An indoor crime preventer comprising a sunshade, e.g. a blind, a roll curtain, or a pleated curtain, disposed on the indoor side to cover a window opening, or the like, and a member for locking the window covering part of the sunshade so as not to move in the direction of opening the window opening, wherein the window covering part has a rigidity of such a level as preventing the window covering part from being bent easily by human power or a tensile strength of such a level as preventing the window covering part from being broken easily by human power.

### TECHNICAL FIELD

The present invention relates to an indoor crime preventer that prevents intrusion from a window, etc., more specifically, an indoor crime preventer structured to prevent intrusion by using a sunshade member such as a blind, a roll curtain, a pleated curtain, etc., disposed on the indoor side so as to cover a window opening, etc.

### BACKGROUND ART

Recently, break-in crimes by burglars, sneak thieves, lock pickers, robbers, etc., who break windows and enter rooms have been increased, and have become a social problem. Generally, for example, a sash is attached to a window opening of a building, and a sliding window glass is fitted into this sash so as to open and close, and in order to prevent the window glass from being opened from the outside, the window is locked from the indoor side by a crescent lock, etc., however, it is not very difficult to break a window that has been locked by the crescent lock as mentioned above for burglars who plan to intrude.

### DISCLOSURE OF THE INVENTION

In view of these circumstances, the present inventors considered that there was a problem in that intrusion was very easily allowed if only the window opening member of the window glass, etc., was broken, and even when the window opening member of the window glass, etc., was broken, if something further blocked the intrusion, a burglar, etc., would be more likely to give up intrusion.

The inventors focused on sunshade members including blinds, roll curtains, pleated curtains and so on disposed on the indoor side to cover the window opening, etc., as an item to further block intrusion even when the window opening and closing member was broken, and considered that the window opening, etc., could be provided with a double crime prevention function by effectively utilizing these.

From this idea as a starting point, the present invention was developed through further earnest study, and an object thereof is to provide an indoor crime preventer that prevents intrusion by using a sunshade member such as a blind, a roll curtain, a pleated curtain, etc., disposed on the indoor side to cover a window opening, etc., whereby providing the window opening, etc., with a double crime prevention function.

In order to achieve the above-mentioned object, the indoor crime preventer relating to the invention comprises a sunshade member which has a window covering part that is disposed on the indoor side to cover a window opening and has a rigidity of such a level as to prevent the window covering part from being bent easily by human power, or a tensile strength of such a level as to prevent the window covering part from being broken easily by human power, and a lock member for selectively latching the window covering part so as not to move in a direction of opening the window opening.

The lock member is preferably structured so as to latch a member positioned at the lowest end of the sunshade member.

As another preferable embodiment, a frame-shaped body is further provided which is formed of a left side part and a right side part having a C-shaped section and into which both ends of the window covering part are inserted, and the lock member has a pair of arms that limit inclination and movement of the window covering part being inserted into the left side part and the right side part when the window covering part is closed.

In the indoor crime preventer thus constructed relating to the invention, since the window covering part has a rigidity of such a level as preventing the window covering part from being bent easily by human power or a tensile strength of such a level as preventing the window covering part from being broken easily by human power, the window covering part serves as a protective wall that blocks intrusion by locking, for example, a member positioned at the lowest end of the sunshade member by a lock mechanism. Namely, for the window opening, a crime prevention function of locking the window covering part can be added to the crime prevention function of locking the window glass.

Herein, conventionally, members that serve as a protective wall for blocking intrusion are not provided, normally inside (indoor side) the window opening and closing member such as a window glass, etc. It is not uncommon that a sunshade member such as a blind, a roll curtain, a pleated curtain, etc., is set on the indoor side from the window opening and closing member such as a window glass, etc., however, the conventional sunshade members are free on their lower end sides although the upper end sides are fixed, and are easily bent and torn apart by human power, so that they cannot be expected as providing a crime prevention effect.

In this case, a burglar, etc., who plans to intrude has been already planted preconception that intrusion will not be blocked by a blind, etc., as mentioned above, and when a burglar, etc., who has thus preconception tries to break into a room by breaking a window glass, etc., if the indoor crime preventer of the invention is set, there is every possibility that the burglar, etc., panics and gives up intruding.

Considering this point, the indoor crime preventer of the invention is required only to have a crime prevention function that acts after the window glass is broken, so that it is not necessary to form the indoor crime preventer to be as strong and accurate as a shutter, etc., set on the outside of the window, and the effect of the indoor crime preventer may be at such a level as causing the burglar, etc., to hesitate to intrude. Therefore, its cost performance for crime prevention is excellent.

### BRIEF DESCRIPTION OF THE DRAWINGS

FIG. 1 is a front view showing a first embodiment of the indoor crime preventer relating to the invention.

FIG. 2 is a partially cut front view around a lock member of the indoor crime preventer shown in FIG. 1 in an enlarged manner.

FIGS. 3 are enlarged sectional views from the A-A arrows of FIG. 2, wherein FIG. 3A shows a lock released state and FIG. 3B shows a locked state.

FIG. 4 is a front view showing a second embodiment of the indoor crime preventer relating to the invention.

FIGS. 5 are enlarged sectional views from the B-B arrows of FIG. 4, wherein FIG. 5A shows a lock released state and FIG. 5B shows a locked state.

FIG. 6 is a front view showing a third embodiment of the indoor crime preventer relating to the invention.

FIG. 7 is a sectional view from the C-C arrows of FIG. 6.

FIGS. 8 are partially enlarged sectional views supplied for description of the lock member provided in the indoor crime preventer shown in FIG. 6 and FIG. 7.

FIG. 9 is a main part sectional view showing a fourth embodiment of the indoor crime preventer relating to the invention.

Hereinafter, embodiments of the invention are described with reference to the drawings. However, the technical scope of the invention is not limited by these embodiments.

### FIRST EMBODIMENT

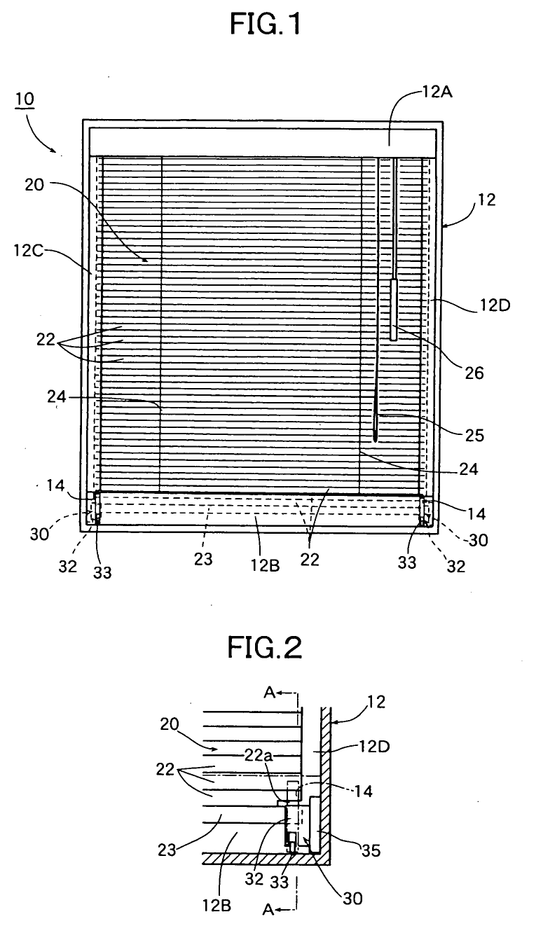

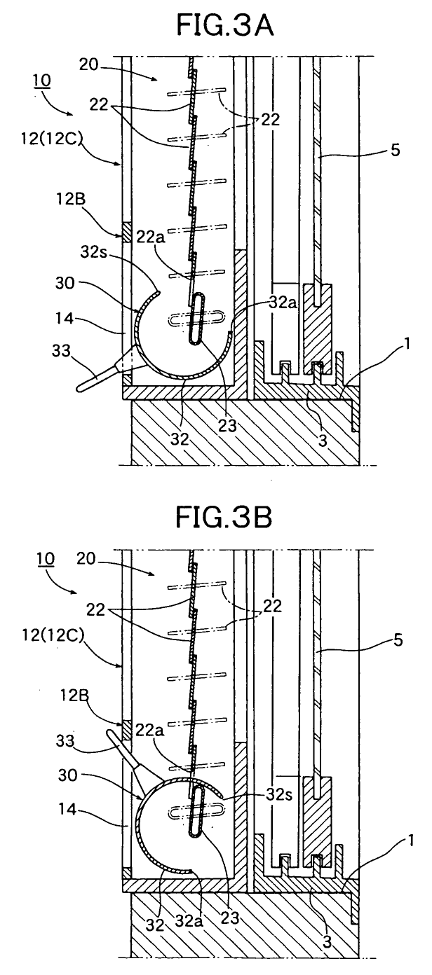

FIG. 1 is a front view showing a first embodiment of the indoor crime preventer relating to the invention. The indoor crime preventer 10 of the first embodiment shown in FIG. 1 is set on the indoor side of a window opening 1 (FIG. 3) of a building. An aluminum sash 3 is attached on the outdoor side of the window opening 1, and a sliding window glass 5 is fitted into this sash 3 so as to freely open and close, and a crescent lock (not shown) , etc., is attached to prevent the window glass 5 from being opened from the outside.

The indoor crime preventer 10 of this embodiment comprises a Venetian blind 20 as a sunshade member, a frame-shaped body 12 installed on the indoor side of the window opening 1, and lock mechanisms 30. In the Venetian blind 20, slats 22 to be used as a window covering part to the window opening 1 are formed of aluminum metal-made or steel-made plates with a length of 90 to 120 cm, a width of 20 to 30 mm, and a plate thickness of 2 to 3 mm, and have a rigidity of such a level as preventing the plates from being bent easily by human power. A bottom rail 23 disposed on the lowest end is roughly the same in length and made of the same material as those of the slats 22, however, the bottom rail is formed into a pipe shape, so that its rigidity and strength are higher than the slats 22.

The slats 22 and the bottom rail 23 are joined in a form of a louver by hoisting cords 24 made of a material with a high tensile strength like a piano wire. A hoisting mechanism for lifting and lowering the slats 22 and an inclination angle adjusting mechanism for changing the inclination angle, etc., are arranged inside the upper side part (head box) 12A of the frame-shaped body 12, and the slats 22 and the bottom rail 23 can be stopped and retained at a position with an arbitrary height by pulling a hoisting string 25 hung down from the upper side part 12A, and the inclination angle of the slats 22 can be changed by turning a pole 26 suspended from the upper side part 12A.

The frame-shaped body 12 is made of an aluminum alloy or a synthetic resin, and has a rectangular shape formed of an upper side part 12A, a lower side part (bottom box) 12B, a left side part (left side box) 12C, and a right side part (right side box) 12D each having a box shape with a C-shaped section, and both ends of the slats 22 and the bottom rail 23 are inserted inside the left side part 12C and the right side part 12D. The left side part 12C and the right side part 12D have a width enabling the slats 22 and the bottom rail 23 to open and close without difficulty as shown in FIG. 3. The slats 22 and the bottom rail 23 near the lower end are inserted inside the lower side part 12B (when they are lowered to the lowest). Notches 22a which make it easy for the lock mechanisms 30 described later to latch to the bottom rail 23 are formed at both ends of the slat 22 at the lowest end.

Lock mechanisms 30 having the same structure are disposed on both left and right ends of the lower side part 12B. The lock mechanisms 30 are structured to latch to both ends of the bottom rail 23 so as to prevent the slats 22 from moving in the direction of opening (upward, herein) the window opening 1. The lock mechanism on the right end side is described below as representative.

FIG. 2 is a partially cut front view around the lock member of the indoor crime preventer shown in FIG. 1 in an enlarged manner. FIGS. 3 are enlarged sectional views from the A-A arrows of FIG. 2, wherein FIG. 3A shows a lock released state and FIG. 3B shows a locked state. As clearly understood by referring to FIG. 2 and FIGS. 3 in addition to FIG. 1, the lock mechanism 30 has a notched cylindrical latching member 32, and this latching member 32 is supported by a short cylindrical spindle 35 fixed to the right side end face portion inside the lower side part 12B in a laterally rotatable manner. A turning lever 33 is attached to the outer circumference of the latching member 32, and this turning lever 33 is made to project forward (toward the indoor side) from the notched opening 14 formed on the lower side part 12B.

When the turning lever 33 is turned down, as shown in FIG. 3A, the notched opening 32a formed in the latching member 32 is turned upward, and in this condition, the bottom rail 23 lowered to the lowest position is inserted into the latching member 32 from the notched opening 32a. On the other hand, when the turning lever 33 is raised from the turned-down state, as shown in FIG. 3B, the latching member 32 rotates and the front end portion 32s thereof in its rotation direction is inserted through the notched portion 22a formed in the lowest slat 22 and comes round to the back side of the bottom rail 23, whereby the right end of the bottom rail 23 becomes unable to be raised up (latched state).

Even if the lowest position of the bottom rail 23 deviates and the front end portion 32s of the latching member 32 in the rotation direction cannot enter the notched portion 22a formed in the lowest slat 22, the slat 22 inclines and creates a space between the slats 22-22 by contact of the front end portion 32s with the slat 22, so that the front end portion 32s enters the space and comes round to the back side of the bottom rail 23. Therefore, the notched portion 22a is not necessarily formed.

Subsequently, the left end portion of the bottom rail 23 is also latched by performing the same operation for the lock mechanism 30 on the left side, whereby the bottom rail 23 is locked, and when the bottom rail 23 is locked, the slats 22 are also locked.

In the indoor crime preventer 10 of this embodiment constructed as mentioned above, the slats 22 have a rigidity of such a level as to prevent the slats from being bent easily by human power, and also, the range of movement thereof is limited by the frame-shaped body 12, and therefore, by locking the bottom rail 23 by the left and right lock mechanisms 30, the blind 20 serves as a protective wall to prevent intrusion even if the window glass 5 is broken. Namely, the crime prevention function of locking the blind 20 is added in addition to the crime prevention function of locking the window glass 5 for the window opening 1.

Generally, a blind is fixed at its upper end side, however, the lower end side is free, and the blind can be bent and torn apart easily by human power, so that it is considered that the blind provides little crime prevention effect. Therefore, when a burglar, etc., tries to enter a room by breaking a window glass, etc., in the case where the indoor crime preventer 10 of this embodiment using the Venetian blind 20 has been set, there is every possibility that the burglar, etc., panics and gives up intruding.

Considering this point, as a premise, the indoor crime preventer 10 of the embodiment is required only to have a crime prevention function that acts after the window glass is broken, so that it is not necessary to form the indoor crime preventer to be as strong and precise as a shutter, etc., set on the outside of the window, and the effect of the indoor crime preventer may be at such a level as causing the burglar, etc., to hesitate to intrude. Therefore, its cost performance for crime prevention is excellent.

In the indoor crime preventer 10 of the first embodiment described above, the bottom rail 23 of the blind 20 is locked, so that the frame-shaped body 12 is not always necessary.

### SECOND EMBODIMENT

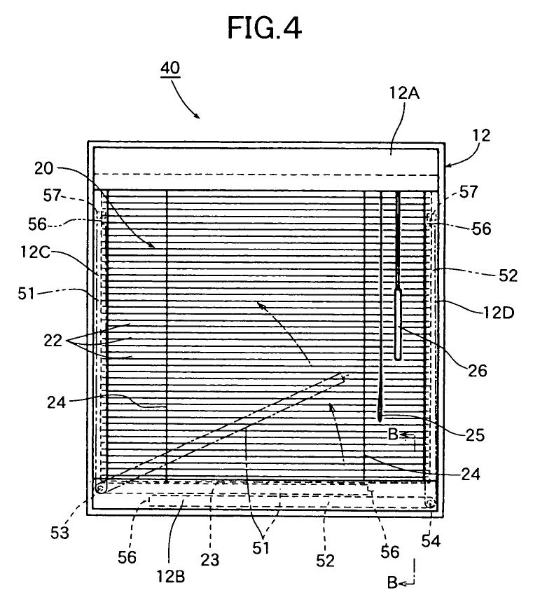

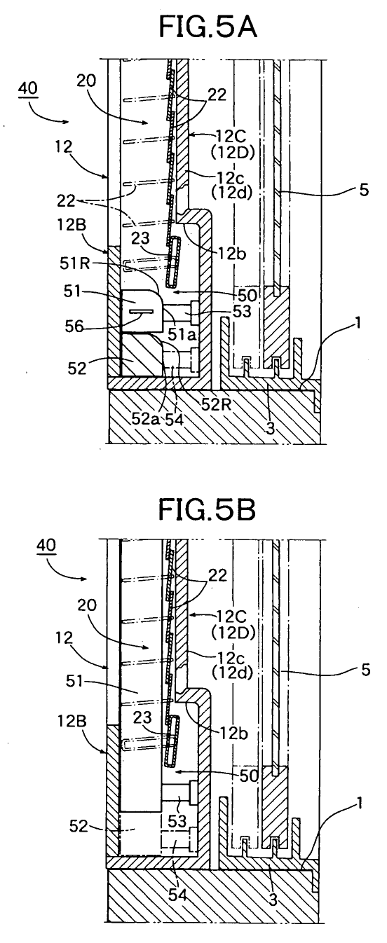

FIG. 4 is a front view showing a second embodiment of the indoor crime preventer relating to the invention. FIGS. 5 are enlarged sectional views from the B-B arrows of FIG. 4, wherein FIG. 5A shows a lock released state and FIG. 5B shows a locked state. The indoor crime preventer 40 of the second embodiment described in FIG. 4 and FIGS. 5 uses a Venetian blind 20 and a frame-shaped body 12 having roughly the same basic constructions as those used in the first embodiment except that lock mechanisms different from those in the first embodiment are used. In the description given below, the same components and the same functional parts as those in the indoor crime preventer 10 of the first embodiment are attached with the same reference signs and overlapping description thereof is omitted, and the points of difference are mainly described below.

The indoor crime preventer 40 of this embodiment uses two arms 51 and 52 as lock mechanisms 50. The arms 51 and 52 are formed into square bars made of an aluminum alloy, a synthetic resin, or wood, etc., and lock both ends of the slats 22 in the blind 20. The arms 51 and 52 are housed inside the lower side part 12B of the frame-shaped body 12 by overlapping vertically in an unlocked state, and to perform locking, the arms are inserted inside the left side part 12C and right side part 12D by being raised from the lower side part 12B and rotated.

In detail, as clearly understood by referring to FIGS. 5, the arm 51 is supported at its base end by a spindle 53 laid across laterally at the left end of the lower side part 12B in a rotatable manner, and the arm 52 is supported at its base end by a spindle 54 laid across laterally at the right end of the lower side part 12B in a rotatable manner. The arms 51 and 52 are housed in the lower side part 12B by being positioned closer to the front face sides (indoor side), and when they are raised, the arms are positioned closer to the front face sides of the left side part 12C and the right side part, and the arms 51 and 52 and the rear face sides 12c and 12d of the left side part 12C and the right side part 12D sandwich the fully-closed slats 22 via slight clearances. The width in the cross direction of the lower side part 12B is set larger than that of the left side part 12C and the right side part 12D so as to withdraw the bottom rail 23 that obstructs rotation of the arms 51 and 52.

In order to prevent the arms 51 and 52 from being caught by the slats 22 and the bottom rail 23 that slightly open (incline) when the arms 51 and 52 are rotated, the corners 51R and 52R formed by the top surface and the rear surface 51a and 52a that become upper and rear surfaces when the arms are housed are rounded. C-shaped handles 56 are attached to the front ends of the arms 51 and 52 for convenience of drawing the arms out of the lower side part 12B. Latching attachment 57 are provided at the upper portions of the left side part 12C and the right side part 12D for latching the handle 56 portions so as to prevent the raised arm 51 from falling down.

In the indoor crime preventer 40 of this embodiment constructed as mentioned above, to perform locking, the slats 22 are fully closed and lowered to the lowest position (the illustrated position), the arm 51 is drawn out of the lower side part 12B, and as shown by an alternate long and short dash line in FIG. 4, the arm is rotated, raised, and inserted into the left side part 12C, and next, the arm 52 is also inserted into the right side part 12D in the same manner.

In the condition where both arms 51 and 52 are thus inserted into the left side part 12C and the right side part 12D, as shown in FIG. 4B, only small spaces are created between the arms 51 and 52 and both ends of the slats 22 and between the slats 22 and the rear surface parts 12c and 12d of the left side part 12C and the right side part 12D. Therefore, when a burglar, etc., who has broken the window glass 5 tries to roll up the slats 22, both ends of the slats 22 are rubbed against the arms 51 and 52 and the rear surface parts 12c and 12d, and are latched. In this case, the slats 22 have a rigidity of such a level as preventing the slats 22 from being bent easily by human power, and even when a hand is put on the slats 22 from the outdoor side (back side), there is no portion to be caught by hand, and the slats are set at an angle close to verticality (80 degrees or more), so that it is impossible to apply a great lifting force. Therefore, due to the slats 22 being locked by the arms 51 and 52, even when the slats 22 are slightly lifted up, the bottom rail 23 is caught and latched by the rear side upper edge 12b of the lower side part 12B, so that it is almost impossible to intrude by breaking the blind 20.

Therefore, the indoor crime preventer 40 of this embodiment also provides a working effect roughly equal to that in the first embodiment.

### THIRD EMBODIMENT

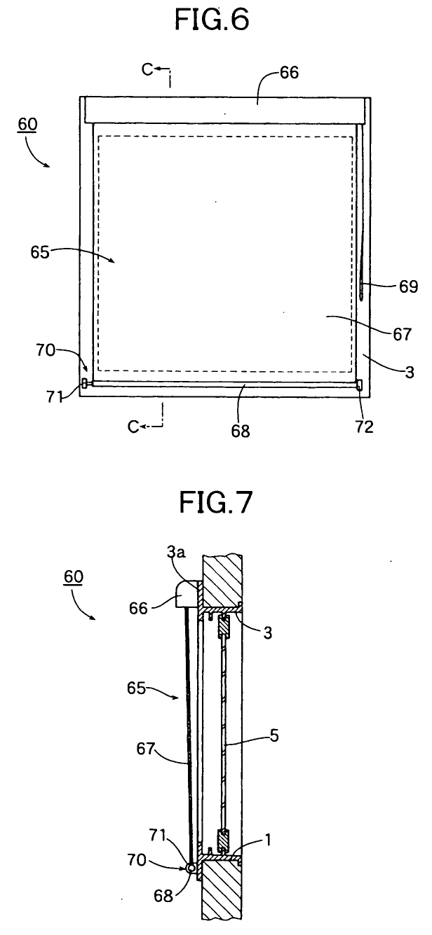

FIG. 6 is a front view showing a third embodiment of the indoor crime preventer relating to the invention. FIG. 7 is a sectional view from the C-C arrows of FIG. 6. The indoor crime preventer 60 of the third embodiment shown in FIG. 6 comprises a roll curtain 65 and a lock mechanism 70. The roll curtain 65 comprises a winding main body part 66, a screen 67 that is made of carbon fibers, etc., and has a tensile strength of such a level as preventing the screen from being broken easily by human power, a weight bar 68 that is attached to the lowest end of this screen 67 and is made of a metal or a synthetic resin having a rigidity of such a level as preventing the weight bar from being bent easily by human power, and a chain 69 for adjusting the height position of the screen 67, and the winding main body part 66 is attached to the upper end of the indoor side face part 3a of the aluminum sash 3 attached to the window opening 1.

The lock mechanism 70 has a left latching attachment 71 and a right latching attachment 72 attached and fixed to both left and right ends of the lower end portion of the aluminum sash 3. The left latching attachment 71 is formed by a fixed arm part 71A attached and fixed to the sash 3 and a bar-shaped latching part 71B that is comparatively long and provided to project laterally inward from the fixed arm part 71A. The right latching attachment 72 is formed by a fixed arm part 72A attached and fixed to the sash 3 and a bar-shaped latching part 72B that is comparatively short and provided to project laterally inward from the fixed arm part 72A.

The indoor crime preventer 60 of this embodiment achieves locking by inserting the bar-shaped latching parts 71B and 72B into both end portions of the weight bar 68 of the roll curtain 65.

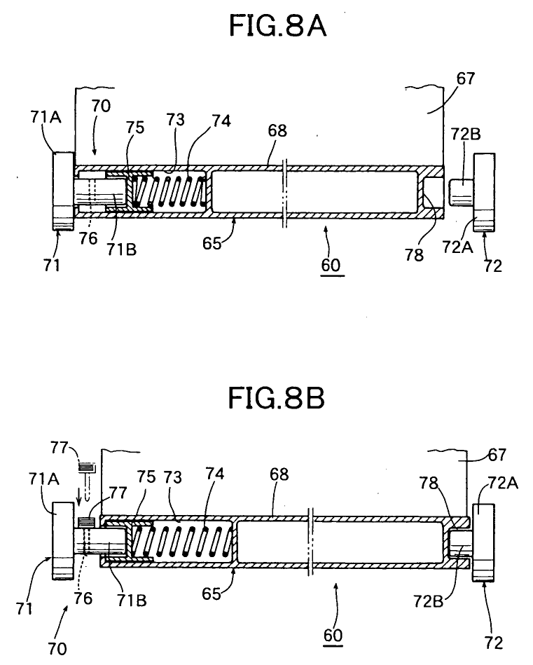

FIG. 8 is a partially enlarged sectional view supplied for description of the lock member provided in the indoor crime preventer shown in FIG. 6 and FIG. 7. In detail, as shown in FIGS. 8, on the left end of the weight bar 68, a bottomed latching hole 73 is formed which is comparatively deep and is provided with a compression coil spring 74 in a compressed state, and on the right end, a latching hole 78 is formed which is comparatively shallow and into which the bar-shaped latching part 72B is inserted. The left end portion of the compression coil spring 74 is inserted into a spring receiver 79 that is to be slid inside the latching hole 73 and has an H-shaped section. A slip preventive latching part 75 is formed on the left end of the latching hole 73.

In the indoor crime preventer 60 of this embodiment constructed as mentioned above, to perform locking, as shown in FIG. 8A, the weight bar 68 is moved to the left and the latching hole 73 provided on the left end is inserted to the bar-shaped latching part 71B from the outside, and subsequently, the latching hole 78 provided on the right end is inserted to the bar-shaped latching part 72B from the outside. Thereby, the weight bar 68 is locked so as not to be pulled up. To release the lock, the weight bar 68 is moved to the left to release the engagement between the latching hole 78 on the right side and the bar-shaped latching part 72B.

Thus, the indoor crime preventer 60 of this embodiment can easily perform locking and unlocking. Accordingly, the possibility of break-in even after the indoor crime preventer performs locking increases. Therefore, as shown in FIG. 8B, it is also possible that a hole 76 is formed in the bar-shaped latching part 71B and a pin 77 is inserted therein. Thereby, the weight bar 68 is prevented from moving laterally, so that the crime prevention function is improved.

In the indoor crime preventer 60 of this embodiment, the weight bar 68 and the screen 67 have a rigidity of such a level as preventing these from being bent easily by human power and a tensile strength of such a level as preventing these from being broken easily by human power, so that by locking the weight bar 68 by the lock mechanism 70 as described above, intrusion is almost impossible.

Therefore, the indoor crime preventer 40 of this embodiment also provides a working effect roughly equal to that in the first and the second embodiment.

### FOURTH EMBODIMENT

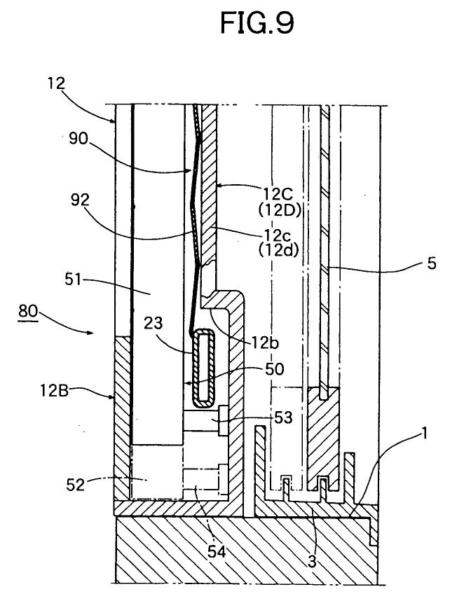

FIG. 9 is a main part sectional view showing a fourth embodiment of the indoor crime preventer relating to the invention. The indoor crime preventer 80 of the fourth embodiment shown in FIG. 9 uses a pleated curtain 90 in place of the blind 29 of the second embodiment, and the constructions of other members including the frame-shaped body 12 and the lock mechanism 50, etc., are almost the same as in the second embodiment. As a material of the curtain member (window covering part) 92 of the pleated curtain 90, a material having a rigidity of such a level as preventing it from being bent easily by human power is used.

In the indoor crime preventer 80 having the above-mentioned construction, to perform locking, the curtain member 92 is stretched from a folded state and lowered to the lowest position (the illustrated position), and the arm 51 is drawn out of the lower side part 12B, raised, and inserted into the left side part 12C, and next, the arm 52 is also inserted into the right side part 12D in the same manner.

In the condition where both arms 51 and 52 are thus inserted into the left side part 12C and the right side part 12D, between the arms 51 and 52 and both ends of the curtain member 92 and between the curtain member 92 and the rear surface parts 12c and 12d of the left side part 12C and the right side part 12D, only small spaces are created. Therefore, when a burglar, etc., who has broken the window glass 5 tries to roll up the curtain member 92, both ends of the curtain member 92 are rubbed against and latched by the arms 51 and 52 and the rear surface parts 12c and 12d.

In this case, the curtain member 92 has a rigidity of such a level as preventing it from being bent easily by human power, and even when a hand is put on the curtain member 92 from the outdoor side (back side), there is no portion to be grappled by hand, and in addition, the curtain member 92 is set at an angle close to verticality (80 degrees or more) , so that it is impossible to apply a great lifting force. Therefore, the curtain member 92 is locked by the arms 51 and 52, and furthermore, even when the curtain member 92 is slightly lifted up, the bottom rail 23 is caught and latched by the rear side upper edge 12b of the lower side part 12B, so that it is almost impossible to intrude by breaking the pleated curtain 90.

Therefore, the indoor crime preventer 80 of this embodiment also provides a working effect roughly equal to that in the second embodiment.

The invention is not limited to the embodiments described above.

For example, the indoor crime preventer of the invention may be attached to a window that is not openable and closable.

### INDUSTRIAL APPLICABILITY

By the invention, intrusion can be prevented by using a sunshade member such as a blind, a roll curtain, or a pleated curtain, etc., disposed on the indoor side to cover a window opening, etc., so that the window opening, etc., can be provided with a double crime prevention function.

What is claimed is:

1. An indoor crime preventer comprising:
a sunshade member which has a window covering part that is disposed on the indoor side to cover a window opening and has a rigidity of such a level as to prevent the window covering part from being bent easily by human power, or a tensile strength of such a level as to prevent the window covering part from being broken easily by human power;
a lock member for selectively latching said window covering part so as not to move in a direction of opening said window opening.

2. The indoor crime preventer according to claim 1, wherein said lock member latches a member positioned at the lowest end of said sunshade member.

3. The indoor crime preventer according to claim 1, further comprising a frame-shaped body having a left side part and a right side part which have a C-shaped section and into which both ends of said window covering part are inserted, wherein
said lock member has a pair of arms which limit the inclination and movement of said window covering part being inserted into said left side part and said right side part when said window covering part is closed.
